(19) United States
(12) Patent Application Publication
(10) Pub. No.: US 2026/0329914 A1
(43) Pub. Date: Oct. 22, 2026

(54) STRUCTURES AND METHODS FOR AUTONOMOUS AGENTS

(71) Applicant: ONCOTELIC, INC., Agoura Hills, CA (US)

(72) Inventors: Vuong TRIEU, Agoura Hills, CA (US); Michael POTTS, Agoura Hills, CA (US); Saran SAUND, Agoura Hills, CA (US)

(21) Appl. No.: 19/690,177

(22) Filed: May 28, 2026

Related U.S. Application Data
(63) Continuation of application No. PCT/US2024/057972, filed on Nov. 29, 2024.
(60) Provisional application No. 63/604,154, filed on Nov. 29, 2023.

(51) Int. Cl. G06F 16/334; G06F 16/355; G06F 16/38

(52) U.S. Cl. CPC G06F 16/3347; G06F 16/355; G06F 16/38

(57) ABSTRACT

This invention relates to methods, systems and media for producing a generative response. The response may be generated using a corpus of documents having non-uniform structure. The corpus can be segmented, tagged, and embedded into a vector database. Agglomerative clustering can be used to organize the information. A query can be formulated and submitted in various modes using a large language model to assemble responses and summaries.

### TECHNICAL FIELD

This invention relates to methods and systems for producing a generative response to a query. The response can be assembled by a large language model.

### BACKGROUND

Large language models (LLM) can be used for a multitude of tasks in manipulating data.

Drawbacks of using large language models include the hallucination effect, where a response to a query appears to contain irrelevant information that is not pertinent to the user.

A further problem is dilution of pertinent information in large databases needed for the LLM to operate. Pertinent information may become a rare portion of the data which cannot be retrieved in a response to a query.

Moreover, in transforming unstructured data such as text documents, the more the data is broken down into manageable pieces that can be structured, then the deeper the system needs to reach to find pertinent information.

An additional problem is that LLM responses tend to converge on an unchanging result even when more and more data is added to the source. Thus, using larger and larger amounts of data is not a solution and does not produce a better result.

What is needed are methods and systems designed to reduce these drawbacks.

There is a need for methods and systems to produce accurate generative responses with pertinent data, such as certain pertinent rare data.

### BRIEF SUMMARY

This invention relates to methods, systems and media for producing a generative response. The response may be generated using a corpus of documents having non-uniform structure. The corpus can be segmented, tagged, and embedded into a vector database. Agglomerative clustering can be used to organize the information. A query can be formulated and submitted in various modes using a large language model to assemble responses and summaries.

In some aspects, a response may be generated by providing a corpus, segmenting the corpus into snippets, clustering the snippets according to content to reduce the number of clusters relative to snippets, embedding all snippets into a vector database, determining by vector-matching the snippets in the query that are a closest to the corpus-snippets, querying in various modes and using a large language model to assemble the response.

Embodiments of this invention include the following:

A method for generating a response to a query, the method comprising:
providing an original corpus comprising textual documents having non-uniform structure, wherein the textual documents comprise one or more natural human languages, and wherein the documents have one or more tags according to content;
extracting the complete text of each document in the original corpus;
segmenting the extracted text into snippets, wherein each snippet has the tags of the document from which it was derived;
generating, for each of the documents and each of the snippets, a vector;
agglomeratively-clustering, for each of the tags, the snippets having the same tag into clusters, wherein each snippet in one of the clusters is semantically similar to each other snippet in the cluster based on vector proximity;
reformulating a first query using a LLM into a second query different from the first query;
identifying by vector-matching the snippets that are a closest match to the first and second queries;
assembling using a LLM the response to the first query based on the snippets that are a closest match to the first and second queries, wherein the assembling is done using the LLM and one of:
   concatenating the query with the full-text of all documents having a tag of interest;
   concatenating the query with the full-text of a single document having a tag of interest of the original corpus to obtain a response, and using the LLM to assemble a summary of the responses for two or more of the documents of the original corpus;
   concatenating the query with a single snippet having a tag of interest to obtain a response, and using the LLM to assemble a summary of the responses obtained for two or more snippets; or
   concatenating the query with all snippets of a cluster having a tag of interest to obtain a response, and using the LLM to assemble a summary of the responses obtained for two or more clusters of snippets.

The method above, wherein the original corpus comprises technical literature publications and patent publications.

The method above, wherein the human languages include one or more languages written or spoken in any member state of the World Intellectual Property Organization.

The method above, wherein the first query is reformulated into up to eight queries different from the first query, wherein the snippets that are a closest match to all the queries are identified.

The method above, wherein any summary contains one or more rare words or tokens which appear in less than 5%, or less than 1%, or less than 0.1% of the combined snippets.

The method above, wherein the total number of snippets is greater than about 100, or greater than about 10E+04, or greater than about 10E+05, greater than about 10E+06.

The method above, wherein each snippet in a cluster matches at least about 30%, or at least about 40%, or at least about 50%, or at least about 60% of the text of each other snippet in the cluster.

The method above, wherein the number of clusters is less than about 5%, or less than about 1%, or less than about 0.1% of the total number of snippets.

The method above, wherein the original corpus comprises textual information in any storage medium data format.

The method above, wherein the original corpus comprises proprietary corporate documents.

The method above, wherein the original corpus comprises web scrapings.

The method above, wherein each vector comprises at least about 50 dimensions, or at least about 100 dimensions, or at least about 500 dimensions.

The method above, wherein the original corpus is machine translated into a select language.

The method above, wherein any summary has higher accuracy as scored by a human panel comparing to a response from a LLM without access to the original corpus.

The method above, wherein the LLM uses one or more tools comprising classification trees, regression trees, decision trees, random forest, principal component analysis, eigenvalue discriminant analysis, kernel least squares, kernel matching, linear regression, non-linear regression, stepwise regression, logistic regression, nearest neighbor regression, neural networks, and support vector machines.

The method above, wherein the LLM is open sourced or closed sourced.

A system, comprising:
one or more processors, servers, or computers and one or more storage devices storing instructions that, when executed by the processors, servers, or computers cause the system to perform the steps comprising:
receiving a multi-language original corpus comprising data with non-uniform structure;
extracting the complete text of each document in the original corpus;
segmenting the extracted text into snippets, wherein each snippet has the tags of the document from which it was derived;
generating, for each of the documents and each of the snippets, a vector;
agglomeratively-clustering, for each of the tags, the snippets having the same tag into clusters, wherein each snippet in one of the clusters is semantically similar to each other snippet in the cluster based on vector proximity;
reformulating a first query using a LLM into a second query different from the first query;
identifying by vector-matching the snippets that are a closest match to the first and second queries;
assembling using a LLM the response to the first query based on the snippets that are a closest match to the first and second queries, wherein the assembling is done using the LLM and one of:
   concatenating the query with the full-text of all documents having a tag of interest;
   concatenating the query with the full-text of a single document having a tag of interest of the original corpus to obtain a response, and using the LLM to assemble a summary of the responses for two or more of the documents of the original corpus;
   concatenating the query with a single snippet having a tag of interest to obtain a response, and using the LLM to assemble a summary of the responses obtained for two or more snippets; or
   concatenating the query with all snippets of a cluster having a tag of interest to obtain a response, and using the LLM to assemble a summary of the responses obtained for two or more clusters of snippets.

The system above, wherein the first query is reformulated into up to eight queries different from the first query, wherein the snippets that are a closest match to all the queries are identified.

The system above, wherein any summary contains one or more rare words or tokens which appear in less than 20%, or less than 5%, or less than 1%, or less than 0.1% of the combined snippets.

The system above, wherein each vector comprises at least about 10 dimensions, or at least about 50 dimensions, or at least about 100 dimensions, or at least about 500 dimensions.

The system above, wherein any summary has higher accuracy as scored by a human panel comparing to a response from a LLM without access to the original corpus.

A non-transient computer-readable medium comprising instructions that, when executed by a processor, server, or computer cause it to perform the steps comprising:
receiving a multi-language original corpus comprising data with non-uniform structure;
extracting the complete text of each document in the original corpus;
segmenting the extracted text into snippets, wherein each snippet has the tags of the document from which it was derived;
generating, for each of the documents and each of the snippets, a vector;
agglomeratively-clustering, for each of the tags, the snippets having the same tag into clusters, wherein each snippet in one of the clusters is semantically similar to each other snippet in the cluster based on vector proximity;
reformulating a first query using a LLM into a second query different from the first query;
identifying by vector-matching the snippets that are a closest match to the first and second queries;
assembling using a LLM the response to the first query based on the snippets that are a closest match to the first and second queries, wherein the assembling is done using the LLM and one of:
   concatenating the query with the full-text of all documents having a tag of interest;
   concatenating the query with the full-text of a single document having a tag of interest of the original corpus to obtain a response, and using the LLM to assemble a summary of the responses for two or more of the documents of the original corpus;
   concatenating the query with a single snippet having a tag of interest to obtain a response, and using the LLM to assemble a summary of the responses obtained for two or more snippets; or
   concatenating the query with all snippets of a cluster having a tag of interest to obtain a response, and using the LLM to assemble a summary of the responses obtained for two or more clusters of snippets.

### BRIEF DESCRIPTION OF THE DRAWINGS

FIG. 1 shows a description of modes and embodiments for providing a pertinent generative response. Upon extraction from the corpus and further processing, querying can be done in monolithic mode, single document mode, cluster document-level mode, or cluster snippet-level mode.

FIG. 2 shows a flow chart of an embodiment of a method for providing a pertinent generative response. Documents are extracted, fragmented into snippets, processed in a vector database with agglomerative clustering, and LLM responses and summaries are generated in various modes. The method advantageously scales efficiently as the corpus increases.

FIG. 3 shows an embodiment of a method and system for providing a pertinent generative response. Documents or fragments extracted from a corpus are clustered according to vector similarity. Clustering advantageously reduces the number of fragments for efficient processing.

FIG. 4 shows an embodiment of a method and system for providing a pertinent generative response. Each document is vectorized and assembled into its distinct hypersphere. A single query can generate multiple responses, each arising from a single document. The responses can be aggregated to provide a clear and accurate summation in-depth.

FIG. 5 shows an embodiment of a method and system for providing a pertinent generative response. Each document is vectorized and assembled into its distinct hypersphere. A single query can generate multiple responses, each arising from a single document. The responses can be aggregated to provide a clear and accurate summation in-depth. In some embodiments, all the information from a single document is utilized.

FIG. 6 shows a description of solutions for providing a pertinent generative response. Shown is a whole-document monolithic mode. A document is ingested as one complete document. In this embodiment, an entire image can be ingested. A whole document chatbot can access, analyze, and reference the content of an entire document, allowing it to answer questions and provide insights based specifically on that document's information.

FIG. 7 shows a description of solutions for providing a pertinent generative response. A monolithic mode is used in which all documents are vectorized and assembled into a single hypersphere from which a single query to the totality of information can be generated. In this embodiment, a document is ingested as one complete document. A whole document chatbot can access, analyze, and reference the content of an entire document, allowing it to answer questions and provide insights based specifically on that document's information.

FIG. 8 shows a description of solutions for providing a pertinent generative response. Shown is document pipeline, wherein each document is vectorized and assembled into its distinct hypersphere. A single query can generate multiple responses, each arising from a single document. These responses then can be aggregated to provide a clear and accurate summation.

FIG. 9 shows a description of solutions for providing a pertinent generative response. Shown is a retrieval pipeline of a monolithic mode, in which all documents are vectorized and assembled into a single hypersphere from when a single query to the totality of information can be generated.

FIG. 10 shows a description of solutions for providing a pertinent generative response. Shown is an input pipeline of an aggregate mode.

FIG. 11 shows a description of solutions for providing a pertinent generative response. Shown is an aggregate mode. Each document is vectorized and assembled into its distinct hypersphere. A single query can generate multiple responses, each arising from a single document. The responses can be aggregated to provide a clear and accurate summation. In this embodiment, all the information from a single image is ingested.

FIG. 12 shows a description of solutions for providing a pertinent generative response. Shown is a whole-document monolithic mode. In this embodiment, a document is ingested as one complete document. A whole document mode can access, analyze, and reference the content of an entire document, allowing it to answer questions and provide insights based specifically on that document's information.

FIG. 13 shows a description of solutions for providing a pertinent generative response. Shown is a cluster mode, vector arrangement, in which documents or fragments are clustered with the cluster containing similar vectors. A single query can generate multiple responses each arising from a single document. The responses can be aggregated to provide a clear and accurate summation.

FIG. 14 shows a description of solutions for providing a pertinent generative response. Shown is a complete overlay of an aggregate fast mode. Each document is vectorized and assembled into its distinct hypersphere. A single query can generate multiple responses, each arising from a single document. The responses can be aggregated to provide a clear and accurate summation.

FIG. 15 shows a description of solutions for providing a pertinent generative response. Shown is a complete overlay of a cluster fast mode. Documents or fragments are clustered with the cluster containing similar vectors. A single query can generate multiple responses, each arising from a single document. The responses can be aggregated to provide a clear and accurate summation.

### DETAILED DESCRIPTION OF THE DISCLOSURE

This invention provides methods, media and systems for producing a generative response to a query. The response can be assembled by a large language model.

This invention involves the ability to fragment any corpus and query the fragments and then combine the responses into a single coherent and accurate summation. The final summation step can be done with LLM technology or other traditional methods of information aggregation. This invention can be used to ingest a large corpus of information and obtain an accurate survey of the corpus. This invention can further provide methods for ingesting documents via fragmenting and obtaining in-depth summations of responses.

Examples of an LLM include GPT (OpenAI), Claude (Anthropic), Gemini (Google), Llama (Meta), and Mixtral (Mistral).

Embodiments of this invention can advantageously reduce hallucination effects caused by large language models. This invention provides methods, devices and systems which can generate a response to a query to contain relevant information that is pertinent to the user. In certain embodiments, the methods, devices and systems of this invention can provide generative responses which include rare facts that would be difficult or impossible to capture with a large language model alone.

In additional aspects, this invention provides methods, devices and systems which can generate a response to a query which overcomes dilution of pertinent information in large databases. Pertinent information in the response may include one or more rare portions of the original data.

Embodiments of this invention can transform unstructured data and break it down into manageable or clustered pieces that can be structured so that pertinent information can be obtained in a response to a query.

This invention provides methods, devices and systems which, in some embodiments, can create pertinent generative responses regardless of size of the data source.

As used herein, the term corpus can refer to a large and structured set of texts or documents. The texts can be in various formats and may include books, articles, web pages, emails, or any other form of written material. The corpus can be a source from which data may be extracted or analyzed. A corpus may be a database of unstructured data.

As used herein, the term breaking down a corpus can refer to the process of deconstructing a large body of text (the corpus) into smaller, more manageable pieces. Breaking down a corpus can make analysis of large volumes of text more feasible. Breaking down a corpus can involve steps and methods including parsing, tokenizing, and segmenting items of the corpus.

Embodiments of this invention may comprise a step or steps for structured segmenting of a corpus, or document, wherein the structure of the document is used to infer split points for fragments or snippets.

As used herein, the term snippet can refer to a small section or fragment of text extracted from a large corpus. The size of a snippet can vary depending on the unstructured nature of the corpus. Regarding textual information in a corpus, a snippet can be a sentence, a paragraph, or any other textual unit that is deemed suitable for extracting meaningful information. Snippets can allow specific, content-accurate and pertinent responses to be obtained from the corpus. A snippet can refer to a relatively small, self-contained portion of text that may be used for processing or generating responses. A snippet can be smaller in size than the complete text of a document, and also large enough to contain meaningful information. A snippet can be a sentence, a paragraph, or a short series of paragraphs. The length of a snippet can vary over a corpus. A snippet can be selected to be easily manageable by a language model. A snippet can be self-contained in context and meaning, and therefore understandable on its own, without requiring additional external information. A language model may process and respond to a snippet accurately. Snippets may be used as inputs for obtaining generative responses. Snippets may also be used for training a model, or for tasks such as text completion, summarization, and question answering. A snippet can provide a focused, concise piece of text that a model may use to understand and respond to a specific query or task.

As used herein, the term extracting can refer to a process of interacting with a large corpus. For example, a language model may extract one or more snippets as information to be used in forming a response to a query. A snippet may be part of a generative response, or provide a basis for a generative response.

As used herein, the term vector can refer to certain coded information based on a snippet. A snippet may be coded or transformed into a vector format. In a vector format, textual information in the snippet may be converted into a numerical form. Because text is inherently non-numerical, it can be converted into a numerical format of a vector that a language model can utilize. Each number in a vector can represent a certain feature or dimension of the text. For example, in a bag-of-words model, each dimension might correspond to a different word in the vocabulary, and the number might represent the presence or frequency of that word in the text. Vectors can be manipulated, compared, and processed by various statistical operations. For example, a language model can perform various operations on vectors such as transformations, scaling, adding, and others known in the art to derive meanings, make predictions, or generate responses. A vector can be a numerical representation of text, where each dimension of the vector encodes various aspects of textual features or meaning. A language model can process and analyze vectorized text using mathematical and statistical methods.

As used herein, the term word embeddings can refer to a manner of representing words or phrases as dense vectors in a high-dimensional space. Each dimension in the vector may capture some aspect of meaning, usage, or relationship of the word with other words. Such embeddings may be learned from large amounts of text data and can capture complex semantic relationships.

Examples of an embedding transformation include OpenAI GPT (via API).

As used herein, the term contextual representation can refer to aspects of transformer architectures in which vectors may also capture contextual information. For example, the same word can have different vector representations depending on its context based on other nearby words, providing a nuanced representation of language.

As used herein, the term language model can refer to a natural language model or a large language model.

### Certain Embodiments of Methods and Systems for Generative Responses

Embodiments of this invention can transform a query into snippets which may be mapped using an embedding model. The process of transforming a question into snippets mapped using an embedding model can involve several steps. In some steps, a natural language question may be converted into a format that can be understood and processed by a language model to generate pertinent responses.

In some aspects, a process may begin with a language model receiving a natural language question from a user. The question may be in the form of a text string.

In further aspects, a question may be preprocessed. A preprocessing step can include cleaning, which may involve removing unnecessary characters or formatting. A preprocessing step can include normalization, which may involve converting characters to lowercase. A preprocessing step can include tokenization, which may involve breaking text into smaller units such as words, subwords, characters, and spaces. In a tokenization step, a question may be broken down into tokens.

As used herein, the term tokens can refer to basic units for language processing. A tokens may be a word, or any part of a word.

In additional aspects, embedding may be used so that each token is transformed into a vector using an embedding model. Embeddings can be learned representations in which words with similar meanings have similar representations. Embeddings can be contextually informed, so that vector representation of a word can change based on surrounding words. Embeddings can be more than just static vectors.

In some embodiments, methods and systems of this invention can provide contextual understanding in which embedding of a token is influenced by the embeddings of other tokens in the question. An LLM based on transformer architecture may use attention mechanisms to understand the context around each word.

In further embodiments, a query in the form of vectors can be mapped to similar or pertinent vectors. Mapping can involve finding snippets having similar vector representations. A language model may search a database for textual snippets that are contextually and semantically pertinent to the query.

Embodiments of this invention can provide generative responses based on mapped snippets and internal knowledge and patterns learned from a corpus. A response may be converted back from vectors to human-readable text.

In certain embodiments, An output step can involve delivering a generated response to the user. A response may be displayed on a device, or read aloud by a device, among other methods.

Aspects of this invention may include generating a response by matching each snippet individually into a specific response, thereby generating responses that are specific to the corpus. A response may not reflect the overall probability of the entire corpus, or information outside the corpus, and may advantageously be focused on a local corpus. A response may advantageously reflect increased levels of rare facts or tokens pertinent to a user. In certain embodiments, a response may be restricted to local corpus, or quoted information within the local corpus.

In certain aspects, each document of a corpus may be broken down in its entirety into snippets. The combination of all such snippets can be equal to the document in its entirety.

Embodiments of this invention can advantageously reduce the number of snippets into a manageable size. In certain embodiments, similar snippets may be clustered together. Similarity of snippets can be based on cosine similarity of vectors, and other measures known in the art. The number of clusters of snippets can be less than one-fourth, or less than one-tenth, or less than one-hundredth of the total number of snippets.

Embodiments of this invention may extract snippets from a document and advantageously reduce their number by clustering similar snippets together. The number of snippets that need to be individually examined or processed may be decreased by clustering to a fraction of the total number of snippets. By reducing the number of clusters relative to individual snippets, processing can be consolidated based on a manageable quantity of clusters. In certain embodiments, a representative snippet from each cluster can provide a good overview or insight into the content of all the snippets in the cluster, thereby reducing the need to examine each one individually.

Additional aspects of this invention can provide control of the process for managing or regulating the number of clusters, by the process for clustering. Controlling the number of clusters can provide manageable amounts of data processing. For example, control can be exercised by parameters such as setting the desired number of clusters based on a fraction of the total number of snippets. Embodiments of this invention allow balancing the clustering to avoid over-simplification of the corpus, or excessive granularity of the corpus.

In further aspects, methods and systems of this invention can enhance accuracy and pertinence of generative responses. A probabilistic response can provide outputs or answers generated by the system based on the likelihood or probability of various outcomes. A probabilistic response can vary by being based on use of statistical models.

Embodiments of this invention can improve responses based on a corpus by restricting certain aspects of a language model. Probabilistic responses can be improved in accuracy and pertinence. Pertinence can measure the degree to which a response is closely related to a query or prompt. Accuracy can measure the degree to which a response is useful to the user.

The depth of the analysis can be adjusted by changing the size of fragments utilized. In some embodiments, documents within a corpus of many documents are used. In certain embodiments, fragments of a document are used. The depth of analysis can be adjusted by changing the size and/or number of documents utilized, or by changing the size and/or number of fragments utilized. Improved control over the depth of analysis can provide a landscape review of the corpus or overall summation analysis of the corpus, as well as reveal minute details of the corpus.

### Certain Operational Steps for Use of Chatbot

In some embodiments, a bot system of this invention may generate text based on a small set of validated documents or information, namely a local corpus.

In some aspects, retrieval augmented generation can be used to capture semantic understanding provided by an LLM to answer questions based purely on the quoted information with a local corpus.

In some embodiments, retrieval augmented generation, neural search or other statistical tools can be used within a different model to map the query text to a high dimensional vector space, in which all the snippets of text from a local corpus of documents have already been embedded. In certain embodiments, a nearest-neighbor search can be used to determine the few corpus snippet vectors which are closest to the query vector.

Embodiments of this invention further contemplate generating a prompt for an LLM to respond to the query using only information within the local corpus. This method advantageously utilizes the full statistical model of the LLM to inform the response, where the prompt can force the system to use only the pertinent information in the response.

In further aspects, a rare fact contained in the quoted document text, which can be exemplified or quantified by tokenization of the corpus, may appear in the generative response.

In some embodiments, a method or system of this invention can perform the following steps in any order.

Receiving a query. In certain embodiments, a web app can be used.

Parsing documents within a local corpus and extracting multiple snippets of text from each one.

Mapping each snippet to an embedding vector.

Mapping the query to an embedding vector.

Determine the N closest snippet vectors to the query vector.

Constructing a prompt containing the snippet text corresponding to the matched snippet vectors, plus the original query, plus instructions about using only the information from the text snippets to answer the query and submits the prompt to an LLM model.

Displaying a response. In certain embodiments, a web app can be used for the displaying.

### Certain Embodiments for Reducing Hallucination

In some embodiments, this invention provides methods for generating a response which can reduce the level of hallucination. A response having a reduced level of hallucination can be provided by including in a query to an LLM a block of contextual content. In certain embodiments, the LLM is restricted to answer the query using only the information in the provided contextual content. In these embodiments, the additional content grounds the LLM response in the context provided and reduces the level of hallucination.

### Certain Embodiments for Dilution Problem

In some embodiments, considering the query or tag of interest, and with an original corpus of potentially relevant documents, this invention can control the level of granularity to map the query to the documents.

In certain embodiments, tags may be applied at the fragment level only, so that the documents are not tagged directly in the database.

In some embodiments, the information required to fully answer the particular query may be spread across multiple documents. In certain embodiments, each individual document can contain extraneous information which is relevant to other questions, even though being irrelevant to the query of interest.

In further embodiments, the relevant information needed for the answer may be referred to as the “signal,” and the irrelevant information the “noise.” This invention can provide a complete and accurate answer to the query by increasing the signal to noise ratio.

In certain embodiments, this invention can provide methods to maximize the signal and minimize the noise within the provided context for the query.

In further embodiments, this invention can provide methods to reduce the dilution problem by increasing the signal to noise ratio.

### Certain Embodiments for Monolithic Querying Mode

In some embodiments, querying may be done in a monolithic mode, where the entire contents of all documents may be queried in a single prompt.

In certain embodiments, the complete text of each document can be extracted, and the contents of all documents concatenated together verbatim to create one single context containing all the information available.

In further embodiments, the combined length of the documents may not exceed any prompt limit, each document is can be highly specific in the context of the question to be answered, and the corpus may be homogeneous. This method can provide a higher signal to noise ratio.

### Certain Embodiments for Document-level Querying Modes

In some embodiments, querying may be done in a document level mode, where the entire contents of each document may be queried as separate prompts.

In some embodiments, the complete text of each document can be extracted, each document's text can be used as context for a separate completion of the same query, and the answers may be concatenated and supplied as context for a single additional prompt asking the LLM to combine them into a single summary answer.

In certain embodiments, the list of individual answers may be used, as well as the combined summary answer.

In further embodiments, each relevant document is highly specific in the context of the question, the corpus may be heterogeneous, and an instruction is included to respond with a standard “N/A” answer in the case of an irrelevant document so that such answers are removed from the combined summary answer prompt.

### Certain Embodiments for Snippet-level Querying Mode

In some embodiments, querying may be done in a snippet level mode, where individual fragments from each document may be queried as separate prompts.

In some embodiments, even though a document may not be sufficiently specific, but may be partitioned into fragments or snippets, such that the text within any given fragment is specific enough for our purposes.

As used herein, the terms fragment and snippet are synonymous.

For example, a fragment or snippet may be a section in a published article or patent publication.

In certain embodiments, snippets may form a partition of the full document text. In these methods, each document may be parsed into snippets. For example, a document may be parsed according to its section heading structure. Each snippet may be considered to be complete and coherent in its own right. In certain embodiments, each snippet's text may be used for a separate completion of the same question. The snippet-level answers may be used, or a combined cross-fragment, cross-document summary answer may be used.

In further embodiments, a document may be parsed into multiple overlapping snippets of text. Each snippet may span multiple sentences. In certain embodiments, each snippet may span multiple paragraphs. Some snippets may overlap where the document is not partitioned according to its inherent structure. This method advantageously minimizes the possibility of inadvertently destroying information by spreading it incoherently across more than one snippet.

### Certain Embodiments for Generative Response Steps

In some embodiments, methods for producing a generative response can include a step for filtering in vector space. A filter can be created which selects relevant fragments as context for a specific query.

In some embodiments, all fragments can be mapped to a hypersphere, and the query may also be mapped to the hypersphere using the same embedding. In these embodiments, all the fragments can be identified whose vector images are sufficiently close to the vector image of the query, for example, using a distance measure such as cosine distance on the hypersphere, and be reasonably certain that the set of fragments so selected are suitably homogenous and also likely semantically relevant to the question.

In certain embodiments, the fragments identified whose vector images are sufficiently close to the vector image of the query can be concatenated into a single prompt. In these embodiments, the required signal may not be significantly diluted, and hence this method can advantageously reduce the number of prompts requiring completions, so that the resulting list of answers and the generated combined summary answer can be more accurate.

In operation of the embodiments of this disclosure, combining multiple fragments into a single prompt in a homogeneous manner in the context of the question can be advantageous. The LLM performs its inferences in a high-dimension vector space, in which sequence of tokens are embedded in the strict mathematical sense by an “embedding” transformation. The predicted token is generated in this vector space and then projected back to the token space before being finally emitted. The embedding transformation is learned, along with the inference coefficients, during an LLM's training phase, and the trained embedding can be extracted and used in isolation, to map any sequence of tokens to the co-domain of the token space in the resulting high-dimension vector space. Typically the embedded token sequences actually live in a hypersphere, itself embedded in the vector space, due to a constraint that forces the vectors to unit length. As a consequence of the LLM training algorithm, a trained embedding can map sequences of tokens that are semantically similar so that they are close together on the hypersphere.

### Some Methods for Clustering

In some embodiments, embedding can be used to identify semantically similar fragments without the context of a specific query by applying a clustering algorithm on the hypersphere. The information contained with the fragments within any given cluster is homogeneous, and heterogeneity arises across the clusters.

In some embodiments, each cluster's text can be submitted separately to an LLM along with a query. The LLM answers only from the clusters which are relevant to that particular query. In certain embodiments, the clusters may be labelled a priori by submitting each cluster's fragments to an LLM along with an instruction to summarize the information which is common to those fragments.

### Scalability of Methods

In some embodiments, the prompts are independent and the per-fragment or per-cluster prompts can be submitted in parallel. The final prompt may combine the non-empty answers generated from the independent prompts and any workarounds to spread the combination request across multiple prompts.

In certain embodiments, a vector database can be used, for example QDRANT, to store the extracted text and fragments. The vector database can be used to scale vertically and also horizontally. In general, there is no limit to the number of documents we can index in this manner.

In further embodiments, methods of this invention can provide a programmatic platform used with an LLM which can leverage the LLM to ingest large amount of information while maintaining accuracy and depth.

In certain embodiments, this invention is scalable because it can be operable with increasing size of the corpus, numbers of documents, and with a large corpus. This invention may also be scalable with increasing number of users. This invention may further be scalable with tags that have increasing numbers of associated documents. This invention may further be scalable with increasing numbers and frequency of queries.

### Certain Embodiments for Verifying Data

In some embodiments, this invention provides methods and systems for verifying data. Such embodiments can advantageously reduce the level of hallucination in responses.

In one embodiment, hallucination of information with curated and accurate data can be reduced. Even when a model is trained exclusively on curated, accurate datasets, hallucination, where a model generates fabricated or incorrect responses, can still occur. This phenomenon arises due to the inherent limitations of large language models (LLMs) and the nature of their training processes.

Embodiments of this invention contemplate reduce the level of hallucination in responses. Co-mingling of concepts in an answer can be avoided because responses may be generated from a single fragment or document, or the aggregate. Further, this invention can reduce the level of hallucination even where uncurated data is utilized. Embodiments of this invention can remove portions of responses that are unsupported or non-factual even where uncurated data is utilized.

Such embodiments utilize accurate and correct assembling of data for a response. Responses from multiple accurate sources can be assembled without combining unrelated information. Therefore a single, coherent concept can be obtained in a factually-correct response. The method for assembling concepts across sources avoids creating new “connections” between concepts that are unsupported by the original data. The method further avoids inappropriately blending knowledge from different concepts or from different fields of knowledge.

### Some Methods and Embodiments

In certain embodiments, the user may bring a collection of documents for assessment. Each document may have a tag or a list of tags. Fragments or snippets from the documents can include the supplied tags. The fragments or snippets can be used in the query process, where the querying specifies the tag or tags of interest, and all, or a subset of all, the fragments or snippets with those tags are used in the process.

As used herein, the term full text block or block can refer to a full text of a document. Fragments or snippets can be fragments of the full text

In some embodiments, an aggregate fast mode is used where information can be extracted as a single document and querying can be done as a single document. Queries may be aggregated to improve accuracy of responses.

In certain embodiments, a corpus may contain 1000 or more documents. A response may be generated for each document and a summary of responses can be generated.

In further embodiments, steps of ingestion of a corpus may include:
providing a corpus comprising documents having non-uniform structure and/or formats
extracting the full text of each document and storing it in a database
splitting a full text into fragments, which may be a structural partition, for example “Abstract” or “Results” sections of literature
arbitrarily overlapping text sequences where structure may not be available
mapping each full-text block and each fragment to a high-dimensional vector space using an “embedding” transformation
storing each full-text block or fragment along with its embedding vector in a database
defining meaningful groups of documents via tags, where each document can be associated with one or more tags, such that a document's tags also apply to the fragments extracted from that document
clustering groups of fragments within each tag based on the proximity of their vectors in a high dimensional vector space.

In additional embodiments, steps of querying may include:
obtaining a query string and a tag from a user
querying a LLM to create from two to five different reformulations of a query, without context
processing a query, including the original query and any reformulations.

In further embodiments, steps of query processing may include one or more of:
(1) monolithic mode, for generating a single answer:
   concatenating a query with full-text of all documents with the supplied tag sending the concatenation to a LLM with a request for an answer
(2) document-level mode, for generating a single answer per document:
   for each document with the supplied tag:
      concatenating a query with full-text of a specific document
      sending the concatenation to a LLM with a request for an answer, or
   sending the per-document answers to a LLM with a request for a summation.
(3) fragment-level mode, for generating a single answer per fragment:
   for each fragment with the supplied tag:
      concatenating the query with the fragment text
      sending the concatenation to a LLM with a request for an answer
   sending the per-fragment answers to a LLM with a request for a summation
(4) cluster-level mode, for generating a single answer per fragment cluster:
   for each cluster with the supplied tag:
      concatenating the query with all the fragments belonging to that cluster
      sending the concatenation to a LLM with a request for an answer
   sending the per-cluster answers to a LLM with a request for a summation.

### Operating Modalities and Embodiments

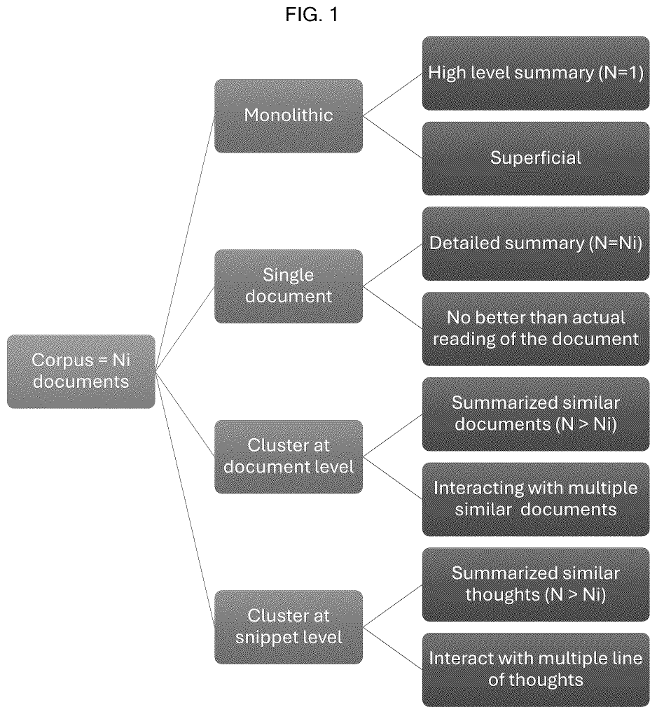

Referring to FIG. 1, in operation, methods for providing a pertinent generative response include steps for querying in monolithic, single document, cluster document, and cluster snippet modes.

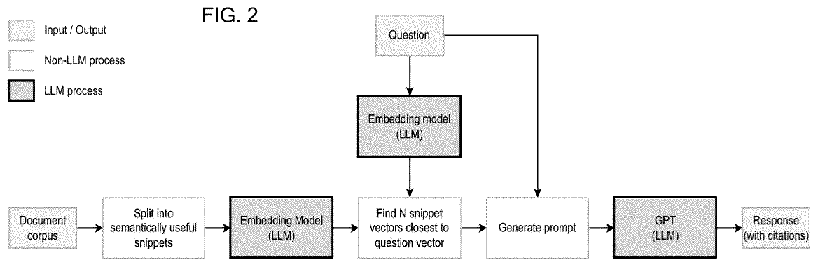

Referring to FIG. 2, in operation, in one embodiment of a method for providing a pertinent generative response, documents are extracted, split into snippets, and embedded as vectors. A query is also embedded as a vector. Matching of the embedded query to the snippets is performed by a processor, which provides a prompt to an LLM to generate a response.

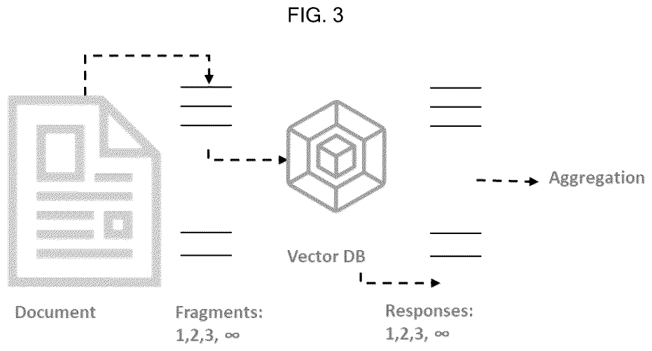

Referring to FIG. 3, in operation, in some embodiments of a method and system for providing a pertinent generative response documents of a corpus are extracted, fragmented, vectorized, and clustered according to vector similarity. Queries are generated using documents or fragments. Queries and fragments are aggregated to generate responses, and responses are aggregated to generate summaries.

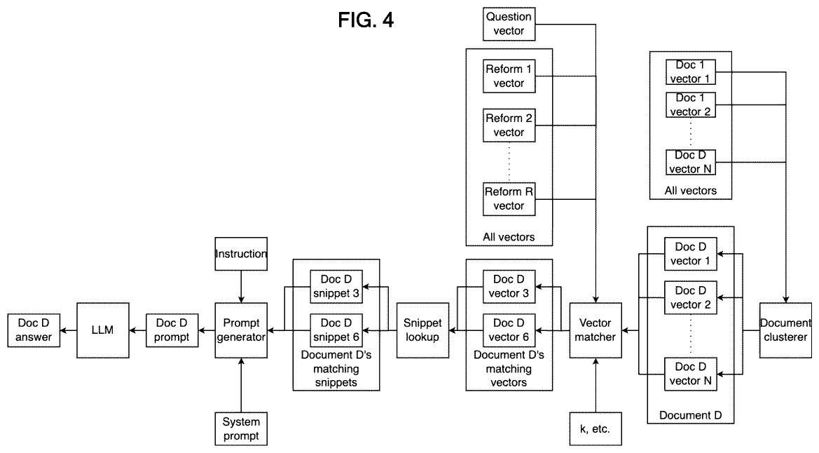

Referring to FIG. 4, in operation, in one embodiment of a method and system for providing a pertinent generative response, each whole document is vectorized and assembled into a distinct document hypersphere. A single query can be used to generate multiple responses, each arising from a single document. The responses can be aggregated to provide a summation.

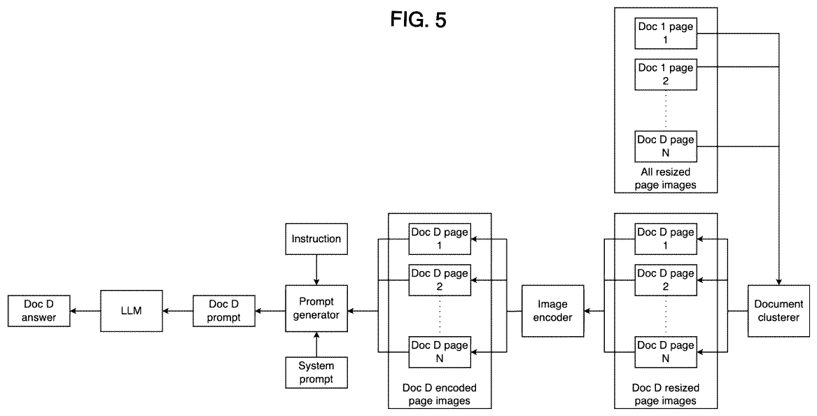

Referring to FIG. 5, in operation, in one embodiment of a method and system for providing a pertinent generative response, documents comprising images are each vectorized and assembled into a distinct hypersphere. A single query can be used to generate multiple responses comprising images, each arising from a single document. The responses can be aggregated to provide a summation. In one embodiment, all the information from a single document is utilized.

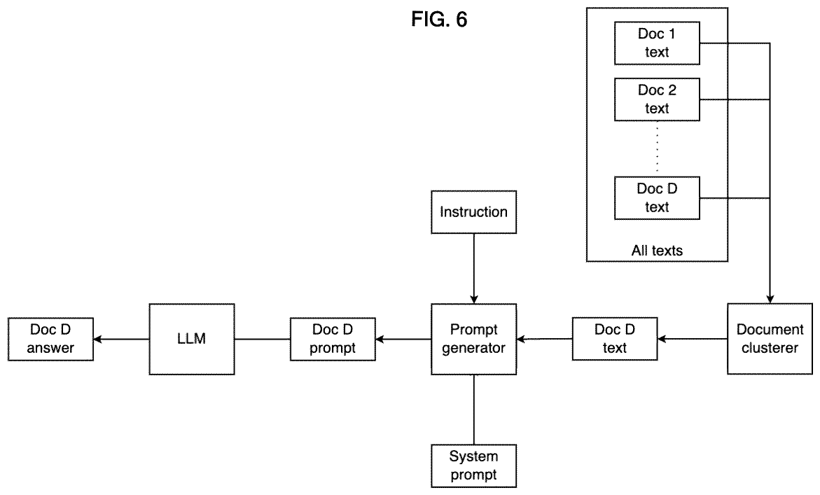

Referring to FIG. 6, in operation, in one embodiment of a method for providing a pertinent generative response, an LLM is prompted in a whole-document monolithic mode. A document is ingested as one complete document. Alternatively, in this embodiment, an entire image can be ingested. A whole document chatbot can access, analyze, and reference the content of an entire document, allowing it to respond to queries and answer questions based specifically on an individual document's entire information content.

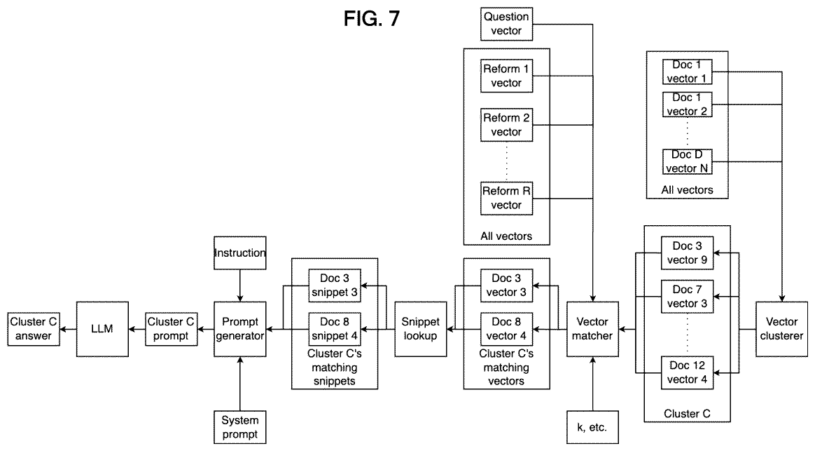

Referring to FIG. 7, in operation, in one embodiment of a method for providing a pertinent generative response, a monolithic mode is arranged in which all documents are vectorized and assembled into a single hypersphere from which a single query to the totality of corpus information content can be generated. In this embodiment, a document is ingested as one complete document. A whole document chatbot can access, analyze, and reference the content of an entire document, allowing it to respond to a query and answer questions based specifically on an individual document's information content.

In some embodiments, a corpus may comprise 10-100 documents having non-uniform format structure, or 10-1,000 documents, or 10-10,000 documents, or 10-50,000documents, or 10-100,000 documents, or 50-10,000 documents, or 100-10,000documents, or 1,000-10,000 documents.

In further embodiments, a document may be split into 2-5 snippets, or 2-10snippets, or 2-100 snippets, or 5-100 snippets, or 10-100 snippets.

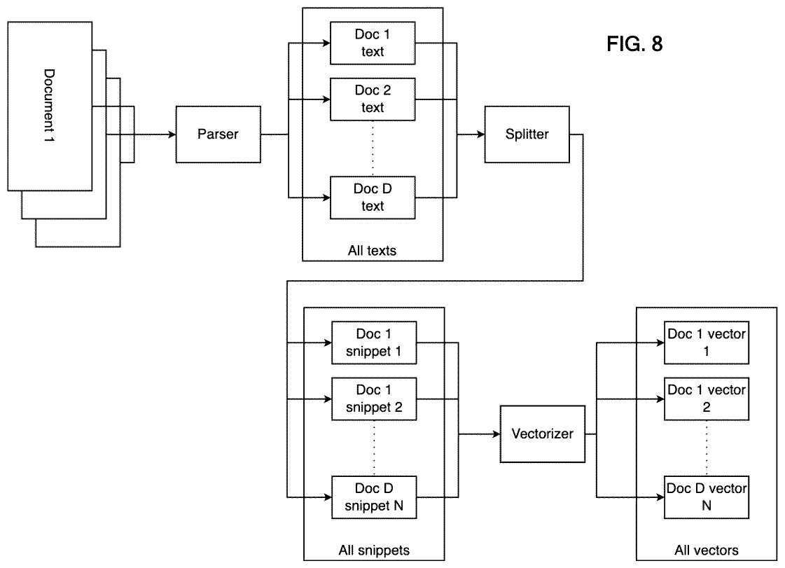

Referring to FIG. 8, in operation, in one embodiment of a method for providing a pertinent generative response, each document of a corpus is extracted, split into snippets, and vectorized into a distinct multidimensional hypersphere. The number of dimensions of the hypersphere can be the number of documents in the corpus, or the number of snippets.

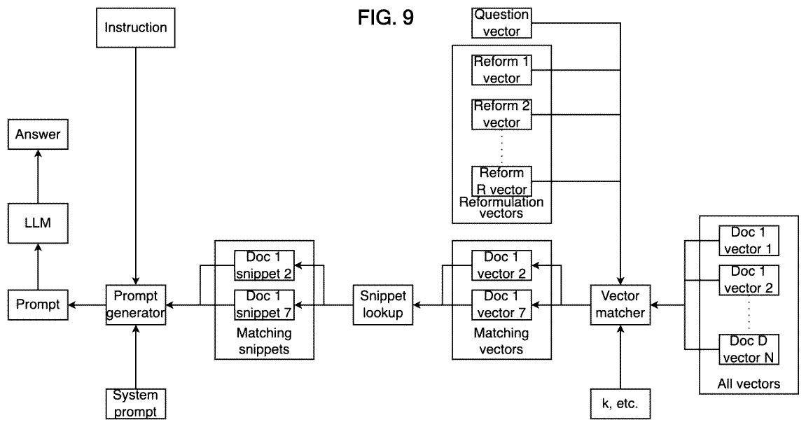

Referring to FIG. 9, in operation, in one embodiment of a method for providing a pertinent generative response, in a retrieval pipeline of a monolithic mode, all documents of a corpus are vectorized and assembled into a single multidimensional hypersphere. A query is reformulate in several different forms. The queries are vector-matched to hypersphere documents to identify a select group of documents. The queries are vector-matched to select snippets of the identified select group of documents. A pertinent generative response is obtained with an LLM using the reformulated queries and the select snippets.

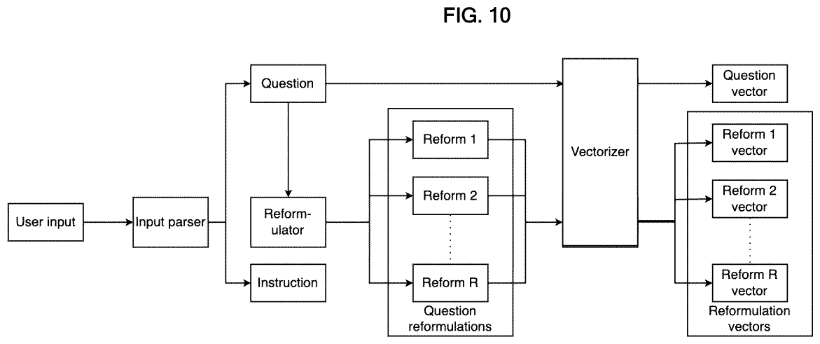

Referring to FIG. 10, in operation, in one embodiment of a method for providing a pertinent generative response, in an input pipeline of an aggregate mode a query is reformulated into several different queries. The original query and the reformulated queries are vectorized.

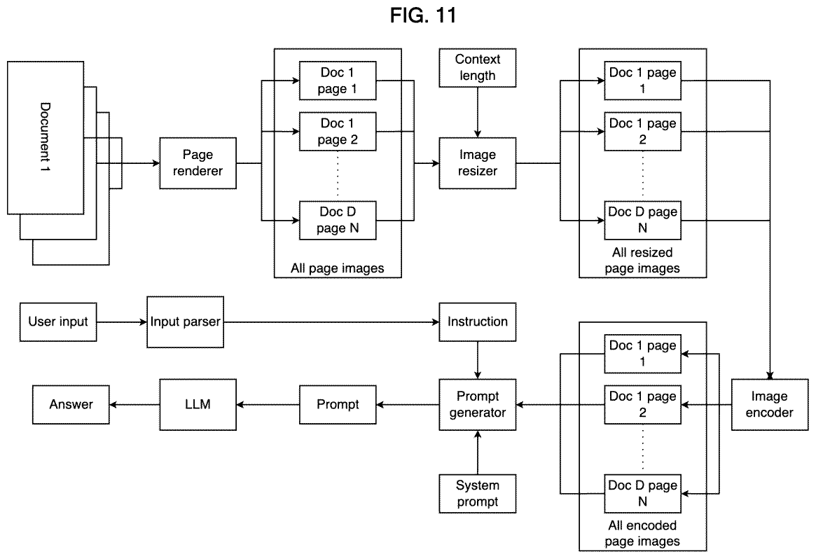

Referring to FIG. 11, in operation, in one embodiment of a method for providing a pertinent generative response, in an aggregate mode each document comprises an image or images which are vectorized and assembled into a distinct multidimensional hypersphere.

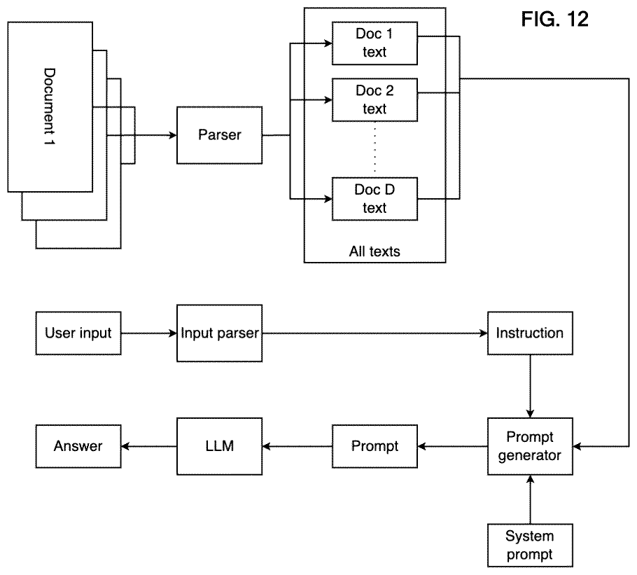

Referring to FIG. 12, in operation, in one embodiment of a method for providing a pertinent generative response, in a whole-document monolithic mode a document is ingested as one complete document. The whole document mode can access, analyze, and reference the content of an entire document, in order to generate a response, answer questions, and summarize responses and answers based specifically on the individual document information content.

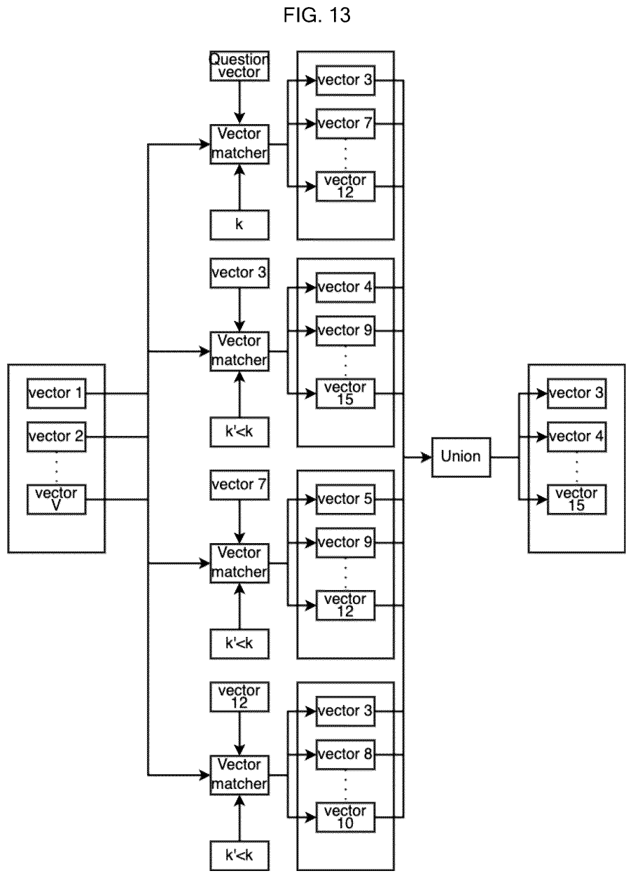

Referring to FIG. 13, in operation, in one embodiment of a method for providing a pertinent generative response, in a cluster mode, documents or fragments are clustered with each cluster containing similar vectors 1, 2, . . . V. A query can vector-matched and unioned to a set of preferred snippets 3,4 . . . 15.

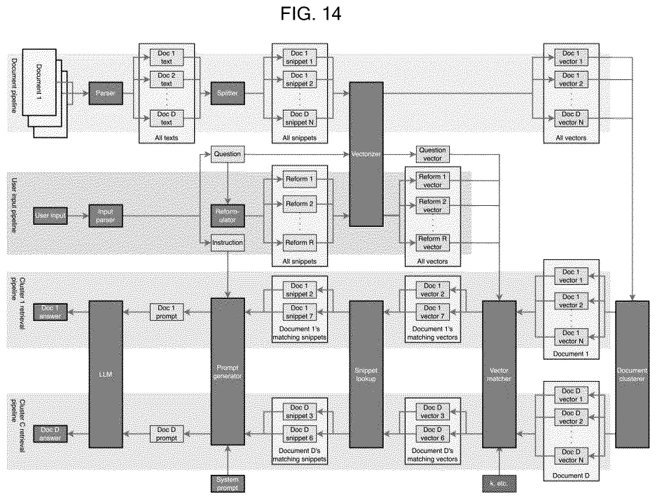

Referring to FIG. 14, in operation, in one embodiment of a method and system for providing a pertinent generative response, a document pipeline comprises steps for processing each document of a corpus. Each document of the corpus is text-extracted, split into snippets, vectorized and assembled into a distinct multidimensional corpus hypersphere. Further, a user input document pipeline comprises steps for processing each user-selected document of interest. Each user-selected document is text-extracted, split into snippets, vectorized and assembled into a distinct multidimensional user-selected hypersphere. Vector-matching between the corpus hypersphere and the user-selected hypersphere identifies snippets of interest. The snippets of interest can be combined with a query or reformulated queries and submitted to an LLM to obtain a pertinent generative response.

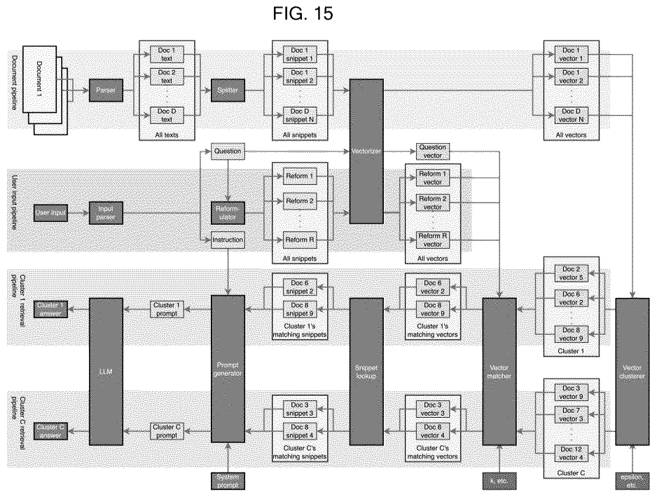

Referring to FIG. 15, in operation, in one embodiment of a method and system for providing a pertinent generative response, a document pipeline comprises steps for processing each document of a corpus. Each document of the corpus is text-extracted, split into snippets, vectorized and assembled into a distinct multidimensional corpus hypersphere. Documents of the corpus hypersphere can be clustered. Further, a user input document pipeline comprises steps for processing each user-selected document of interest. Each user-selected document is text-extracted, split into snippets, vectorized and assembled into a distinct multidimensional user-selected hypersphere. Vector-matching between the clustered corpus hypersphere and the user-selected hypersphere identifies snippets of interest. The snippets of interest can be combined with a query or reformulated queries and submitted to an LLM to obtain a pertinent generative response.

Further embodiments of this invention include the following:

A method for producing a generative response, the method comprising: providing a multi-language original corpus comprising data with non-uniform structure; segmenting the original corpus into textual data-snippets, wherein the total number of data-snippets is greater than about 10E03; clustering the data-snippets according to textual content, wherein each data-snippet in a cluster matches at least about 40% of the text of each other data-snippet in the cluster, and wherein the number of clusters is less than about 10% of the total number of data-snippets; segmenting a query into textual query-snippets and mapping the query-snippets to the clustered-corpus of data-snippets; embedding the clustered data-snippets and query-snippets into a vector database; determining, by vector-matching, close-data-snippets in the clustered-corpus that are a closest textual match to the query-snippets; using a large language model to assemble a response to a modified query, wherein the modified query is restricted to the close-data-snippets, and wherein the large language model accesses public information outside the corpus.

The method of above, wherein the retrieval augmented search is a retrieval augmented search, neural network search, or machine learning search.

The method above, wherein the large language model does not access information outside the corpus.

The method above, wherein the response contains one or more rare tokens which appear in less than 5%, or less than 1%, or less than 0.1% of the combined data-snippets.

The method above, wherein the total number of data-snippets is greater than about 10E04, or greater than about 10E05, greater than about 10E06.

The method above, wherein each data-snippet in a cluster matches at least about 50%, or at least about 60%, or at least about 70% of the text of each other data-snippet in the cluster.

The method above, wherein the number of clusters is less than about 5%, or less than about 1%, or less than about 0.1% of the total number of data-snippets.

The method above, wherein the corpus comprises textual information in any storage medium data format.

The method above, wherein the corpus comprises documents comprising textual information.

The method above, wherein the corpus comprises corporate documents.

The method above, wherein the corpus comprises scientific journal publications.

The method above, wherein the corpus comprises web scrapings.

The method above, wherein the corpus is a local corpus comprising proprietary documents.

The method above, wherein the embedding comprises at least about 50 dimensions, or at least about 100 dimensions, or at least about 500 dimensions.

The method above, wherein the corpus is machine translated into a selected language.

The method above, wherein the response has higher accuracy as scored by a human panel comparing to a response from a large language model without access to the original corpus.

The method above, wherein the large language model uses one or more tools comprising classification trees, regression trees, decision trees, random forest, principal component analysis, eigenvalue discriminant analysis, kernel least squares, kernel matching, linear regression, non-linear regression, stepwise regression, logistic regression, nearest neighbor regression, neural networks, and support vector machines.

The method above, wherein the large language model is open sourced or closed sourced.

A system, comprising:
one or more processors, servers, or computers and one or more storage devices storing instructions that, when executed by the processors, servers, or computers cause the system to perform the steps comprising:
receiving a multi-language original corpus comprising data with non-uniform structure;
segmenting the original corpus into textual data-snippets, wherein the total number of data-snippets is greater than about 10E03;
clustering the data-snippets according to textual content, wherein each data-snippet in a cluster matches at least about 40% of the text of each other data-snippet in the cluster, and wherein the number of clusters is less than about 10% of the total number of data-snippets;
segmenting a query into textual query-snippets and mapping the query-snippets to the clustered-corpus of data-snippets;
embedding the clustered data-snippets and query-snippets into a vector database;
determining, by vector-matching, close-data-snippets in the clustered-corpus that are a closest textual match to the query-snippets;
using a large language model to assemble a response to a modified query, wherein the modified query is restricted to the close-data-snippets, and wherein the large language model accesses public information outside the corpus.

A non-transient computer-readable medium comprising instructions that, when executed by a processor, server, or computer cause it to perform the steps comprising:
receiving a multi-language original corpus comprising data with non-uniform structure;
segmenting the original corpus into textual data-snippets, wherein the total number of data-snippets is greater than about 10E03;
clustering the data-snippets according to textual content, wherein each data-snippet in a cluster matches at least about 40% of the text of each other data-snippet in the cluster, and wherein the number of clusters is less than about 10% of the total number of data-snippets;
segmenting a query into textual query-snippets and mapping the query-snippets to the clustered-corpus of data-snippets;
embedding the clustered data-snippets and query-snippets into a vector database;
determining, by vector-matching, close-data-snippets in the clustered-corpus that are a closest textual match to the query-snippets;
using a large language model to assemble a response to a modified query, wherein the modified query is restricted to the close-data-snippets, and wherein the large language model accesses public information outside the corpus.

Numbered embodiments of this invention include the following:
(1) A method for generating a response to a query, the method comprising:
   providing an original corpus comprising textual documents having non-uniform structure, wherein the textual documents comprise one or more natural human languages, and wherein the documents have one or more tags according to content;
   extracting the complete text of each document in the original corpus;
   segmenting the extracted text into snippets, wherein each snippet has the tags of the document from which it was derived;
   generating, for each of the documents and each of the snippets, a vector;
   agglomeratively-clustering, for each of the tags, the snippets having the same tag into clusters, wherein each snippet in one of the clusters is semantically similar to each other snippet in the cluster based on vector proximity;
   reformulating a first query using a LLM into a second query different from the first query;
   identifying by vector-matching the snippets that are a closest match to the first and second queries;
   assembling using a LLM the response to the first query based on the snippets that are a closest match to the first and second queries, wherein the assembling is done using the LLM and one of:
      concatenating the query with the full-text of all documents having a tag of interest;
      concatenating the query with the full-text of a single document having a tag of interest of the original corpus to obtain a response, and using the LLM to assemble a summary of the responses for two or more of the documents of the original corpus;
      concatenating the query with a single snippet having a tag of interest to obtain a response, and using the LLM to assemble a summary of the responses obtained for two or more snippets; or
      concatenating the query with all snippets of a cluster having a tag of interest to obtain a response, and using the LLM to assemble a summary of the responses obtained for two or more clusters of snippets.
(2) The method of embodiment 1, wherein the original corpus comprises technical literature publications or patent publications or both.
(3) The method of any of embodiments 1-2, wherein the human languages include one or more languages written or spoken in any member state of the World Intellectual Property Organization.
(4) The method of any of embodiments 1-3, wherein the first query is reformulated into up to eight queries different from the first query, wherein the snippets that are a closest match to all the queries are identified.
(5) The method of any of embodiments 1-4, wherein any summary contains one or more rare words or tokens which appear in less than 5%, or less than 1%, or less than 0.1% of the combined snippets.
(6) The method of any of embodiments 1-5, wherein the total number of snippets is greater than about 100, or greater than about 10E+04, or greater than about 10E+05, greater than about 10E+06.
(7) The method of any of embodiments 1-6, wherein each snippet in a cluster matches at least about 30%, or at least about 40%, or at least about 50%, or at least about 60% of the text of each other snippet in the cluster.
(8) The method of any of embodiments 1-7, wherein the number of clusters is less than about 5%, or less than about 1%, or less than about 0.1% of the total number of snippets.
(9) The method of any of embodiments 1-8, wherein the original corpus comprises textual information in any storage medium data format.
(10) The method of any of embodiments 1-9, wherein the original corpus comprises proprietary corporate documents.
(11) The method of any of embodiments 1-10, wherein the original corpus comprises web scrapings.
(12) The method of any of embodiments 1-11, wherein each vector comprises at least about 50 dimensions, or at least about 100 dimensions, or at least about 500 dimensions.
(13) The method of any of embodiments 1-12, wherein the original corpus is machine translated into a select language.
(14) The method of any of embodiments 1-13, wherein any summary has higher accuracy as scored by a human panel comparing to a response from a LLM without access to the original corpus.
(15) The method of any of embodiments 1-14, wherein the LLM uses one or more tools comprising classification trees, regression trees, decision trees, random forest, principal component analysis, eigenvalue discriminant analysis, kernel least squares, kernel matching, linear regression, non-linear regression, stepwise regression, logistic regression, nearest neighbor regression, neural networks, and support vector machines.
(16) The method of any of embodiments 1-15, wherein the LLM is open sourced or closed sourced.
(17) A system, comprising:
   one or more processors, servers, or computers and one or more storage devices storing instructions that, when executed by the processors, servers, or computers cause the system to perform the steps comprising:
   receiving a multi-language original corpus comprising data with non-uniform structure;
   extracting the complete text of each document in the original corpus;
   segmenting the extracted text into snippets, wherein each snippet has the tags of the document from which it was derived;
   generating, for each of the documents and each of the snippets, a vector;
   agglomeratively-clustering, for each of the tags, the snippets having the same tag into clusters, wherein each snippet in one of the clusters is semantically similar to each other snippet in the cluster based on vector proximity;
   reformulating a first query using a LLM into a second query different from the first query;
   identifying by vector-matching the snippets that are a closest match to the first and second queries;
   assembling using a LLM the response to the first query based on the snippets that are a closest match to the first and second queries, wherein the assembling is done using the LLM and one of:
      concatenating the query with the full-text of all documents having a tag of interest;
      concatenating the query with the full-text of a single document having a tag of interest of the original corpus to obtain a response, and using the LLM to assemble a summary of the responses for two or more of the documents of the original corpus;
      concatenating the query with a single snippet having a tag of interest to obtain a response, and using the LLM to assemble a summary of the responses obtained for two or more snippets; or
      concatenating the query with all snippets of a cluster having a tag of interest to obtain a response, and using the LLM to assemble a summary of the responses obtained for two or more clusters of snippets.
(18) The system of embodiment 17, wherein the first query is reformulated into up to eight queries different from the first query, wherein the snippets that are a closest match to all the queries are identified.
(19) The system of any of embodiments 17-18, wherein any summary contains one or more rare words or tokens which appear in less than 20%, or less than 5%, or less than 1%, or less than 0.1% of the combined snippets.
(20) The system of any of embodiments 17-19, wherein each vector comprises at least about 10 dimensions, or at least about 50 dimensions, or at least about 100 dimensions, or at least about 500 dimensions.
(21) The system of any of embodiments 17-20, wherein any summary has higher accuracy as scored by a human panel comparing to a response from a LLM without access to the original corpus.
(22) A non-transient computer-readable medium comprising instructions that, when executed by a processor, server, or computer cause it to perform the steps comprising:
   receiving a multi-language original corpus comprising data with non-uniform structure;
   extracting the complete text of each document in the original corpus;
   segmenting the extracted text into snippets, wherein each snippet has the tags of the document from which it was derived;
   generating, for each of the documents and each of the snippets, a vector;
   agglomeratively-clustering, for each of the tags, the snippets having the same tag into clusters, wherein each snippet in one of the clusters is semantically similar to each other snippet in the cluster based on vector proximity;
   reformulating a first query using a LLM into a second query different from the first query;
   identifying by vector-matching the snippets that are a closest match to the first and second queries;
   assembling using a LLM the response to the first query based on the snippets that are a closest match to the first and second queries, wherein the assembling is done using the LLM and one of:
      concatenating the query with the full-text of all documents having a tag of interest;
      concatenating the query with the full-text of a single document having a tag of interest of the original corpus to obtain a response, and using the LLM to assemble a summary of the responses for two or more of the documents of the original corpus;
      concatenating the query with a single snippet having a tag of interest to obtain a response, and using the LLM to assemble a summary of the responses obtained for two or more snippets; or
      concatenating the query with all snippets of a cluster having a tag of interest to obtain a response, and using the LLM to assemble a summary of the responses obtained for two or more clusters of snippets.

All publications including patents, patent application publications, and non-patent publications referred to in this description are each expressly incorporated herein by reference in their entirety for all purposes.

Although the foregoing disclosure has been described in detail by way of example for purposes of clarity of understanding, it will be apparent to the artisan that certain changes and modifications are comprehended by the disclosure and may be practiced without undue experimentation within the scope of the appended claims, which are presented by way of illustration not limitation. This invention includes all such additional embodiments, equivalents, and modifications. This invention includes any combinations of the features, elements, or limitations of the various embodiments.

It is emphasized herein according to common practice the features of the drawings have arbitrary scale and are intended to cover similar features that may be arbitrarily expanded or reduced.

What is claimed is:

1. A method for generating a response to a query, the method comprising:
providing an original corpus comprising textual documents having non-uniform structure, wherein the textual documents comprise one or more natural human languages, and wherein the documents have one or more tags according to content;
extracting the complete text of each document in the original corpus;
segmenting the extracted text into snippets, wherein each snippet has the tags of the document from which it was derived;
generating, for each of the documents and each of the snippets, a vector;
agglomeratively-clustering, for each of the tags, the snippets having the same tag into clusters, wherein each snippet in one of the clusters is semantically similar to each other snippet in the cluster based on vector proximity;
reformulating a first query using a LLM into a second query different from the first query;
identifying by vector-matching the snippets that are a closest match to the first and second queries;
assembling using a LLM the response to the first query based on the snippets that are a closest match to the first and second queries, wherein the assembling is done using the LLM and one of:
concatenating the query with the full-text of all documents having a tag of interest;
concatenating the query with the full-text of a single document having a tag of interest of the original corpus to obtain a response, and using the LLM to assemble a summary of the responses for two or more of the documents of the original corpus;
concatenating the query with a single snippet having a tag of interest to obtain a response, and using the LLM to assemble a summary of the responses obtained for two or more snippets; or
concatenating the query with all snippets of a cluster having a tag of interest to obtain a response, and using the LLM to assemble a summary of the responses obtained for two or more clusters of snippets.

2. The method of claim 1, wherein the original corpus comprises technical literature publications or patent publications or both.

3. The method of claim 1, wherein the human languages include one or more languages written or spoken in any member state of the World Intellectual Property Organization.

4. The method of claim 1, wherein the first query is reformulated into up to eight queries different from the first query, wherein the snippets that are a closest match to all the queries are identified.

5. The method of claim 1, wherein any summary contains one or more rare words or tokens which appear in less than 5%, or less than 1%, or less than 0.1% of the combined snippets.

6. The method of claim 1, wherein the total number of snippets is greater than about 100, or greater than about 10E+04, or greater than about 10E+05, greater than about 10E+06.

7. The method of claim 1, wherein each snippet in a cluster matches at least about 30%, or at least about 40%, or at least about 50%, or at least about 60% of the text of each other snippet in the cluster.

8. The method of claim 1, wherein the number of clusters is less than about 5%, or less than about 1%, or less than about 0.1% of the total number of snippets.

9. The method of claim 1, wherein the original corpus comprises textual information in any storage medium data format.

10. The method of claim 1, wherein the original corpus comprises proprietary corporate documents.

11. The method of claim 1, wherein the original corpus comprises web scrapings.

12. The method of claim 1, wherein each vector comprises at least about 50 dimensions, or at least about 100 dimensions, or at least about 500 dimensions.

13. The method of claim 1, wherein the original corpus is machine translated into a select language.

14. The method of claim 1, wherein any summary has higher accuracy as scored by a human panel comparing to a response from a LLM without access to the original corpus.

15. The method of claim 1, wherein the LLM uses one or more tools comprising classification trees, regression trees, decision trees, random forest, principal component analysis, eigenvalue discriminant analysis, kernel least squares, kernel matching, linear regression, non-linear regression, stepwise regression, logistic regression, nearest neighbor regression, neural networks, and support vector machines.

16. The method of claim 1, wherein the LLM is open sourced or closed sourced.

17. A system, comprising:
one or more processors, servers, or computers and one or more storage devices storing instructions that, when executed by the processors, servers, or computers cause the system to perform the steps comprising:
receiving a multi-language original corpus comprising data with non-uniform structure;
extracting the complete text of each document in the original corpus;
segmenting the extracted text into snippets, wherein each snippet has the tags of the document from which it was derived;
generating, for each of the documents and each of the snippets, a vector;
agglomeratively-clustering, for each of the tags, the snippets having the same tag into clusters, wherein each snippet in one of the clusters is semantically similar to each other snippet in the cluster based on vector proximity;
reformulating a first query using a LLM into a second query different from the first query;
identifying by vector-matching the snippets that are a closest match to the first and second queries;
assembling using a LLM the response to the first query based on the snippets that are a closest match to the first and second queries, wherein the assembling is done using the LLM and one of:
concatenating the query with the full-text of all documents having a tag of interest;
concatenating the query with the full-text of a single document having a tag of interest of the original corpus to obtain a response, and using the LLM to assemble a summary of the responses for two or more of the documents of the original corpus;
concatenating the query with a single snippet having a tag of interest to obtain a response, and using the LLM to assemble a summary of the responses obtained for two or more snippets; or
concatenating the query with all snippets of a cluster having a tag of interest to obtain a response, and using the LLM to assemble a summary of the responses obtained for two or more clusters of snippets.

18. The system of claim 17, wherein the first query is reformulated into up to eight queries different from the first query, wherein the snippets that are a closest match to all the queries are identified.

19. The system of claim 17, wherein any summary contains one or more rare words or tokens which appear in less than 20%, or less than 5%, or less than 1%, or less than 0.1% of the combined snippets.

20. The system of claim 17, wherein each vector comprises at least about 10 dimensions, or at least about 50 dimensions, or at least about 100 dimensions, or at least about 500 dimensions.

21. The system of claim 17, wherein any summary has higher accuracy as scored by a human panel comparing to a response from a LLM without access to the original corpus.

22. A non-transient computer-readable medium comprising instructions that, when executed by a processor, server, or computer cause it to perform the steps comprising:
receiving a multi-language original corpus comprising data with non-uniform structure;
extracting the complete text of each document in the original corpus;
segmenting the extracted text into snippets, wherein each snippet has the tags of the document from which it was derived;
generating, for each of the documents and each of the snippets, a vector;
agglomeratively-clustering, for each of the tags, the snippets having the same tag into clusters, wherein each snippet in one of the clusters is semantically similar to each other snippet in the cluster based on vector proximity;
reformulating a first query using a LLM into a second query different from the first query;
identifying by vector-matching the snippets that are a closest match to the first and second queries;
assembling using a LLM the response to the first query based on the snippets that are a closest match to the first and second queries, wherein the assembling is done using the LLM and one of:
concatenating the query with the full-text of all documents having a tag of interest;
concatenating the query with the full-text of a single document having a tag of interest of the original corpus to obtain a response, and using the LLM to assemble a summary of the responses for two or more of the documents of the original corpus;
concatenating the query with a single snippet having a tag of interest to obtain a response, and using the LLM to assemble a summary of the responses obtained for two or more snippets; or
concatenating the query with all snippets of a cluster having a tag of interest to obtain a response, and using the LLM to assemble a summary of the responses obtained for two or more clusters of snippets.
